(19) United States
(12) Patent Application Publication
(10) Pub. No.: US 2023/0375591 A1
(43) Pub. Date: Nov. 23, 2023

(54) PREDICTION METHOD FOR MAXIMUM VELOCITY PROFILE IN WAVE BOUNDARY LAYER BASED ON VELOCITY DEFECT FUNCTIONS

(71) Applicant: DALIAN UNIVERSITY OF TECHNOLOGY, Dalian (CN)

(72) Inventors: Guoqiang TANG, Dalian (CN); Lin LV, Dalian (CN); Dongsheng QIAO, Dalian (CN); Zhiwei SONG, Dalian (CN); Jun YAN, Dalian (CN); Xiaohui YAN, Dalian (CN); Yunfei TENG, Dalian (CN); Chen LI, Dalian (CN)

(21) Appl. No.: 18/319,148

(22) Filed: May 17, 2023

(30) Foreign Application Priority Data
May 19, 2022 (CN) 202210544017.8

(51) Int. Cl. G01P 5/00; G06F 17/12

(52) U.S. Cl. CPC G01P 5/001; G06F 17/12

(57) ABSTRACT

The present invention discloses a prediction method for a maximum velocity profile in a wave boundary layer based on velocity defect functions. The method overcomes the theoretical defects of the existing velocity defect functions. That is, the velocity profile in a turbulent wave boundary layer cannot be realized; and in addition, without the assumption of linear wave conditions, the method is suitable for nonlinear waves and at the same time, for a small A/k, range, and can be extended to the analysis and prediction for the maximum velocity profile under the condition that the spatial distribution of roughness elements of gravel seabed, etc. obviously affects the flow structure of the boundary layer. The present invention can be directly applied to the analysis and prediction for physical quantities/processes, such as characteristics of the wave boundary layer, stress of underwater structures, and starting and transport of submarine sediments.

### TECHNICAL FIELD

The present invention relates to the research fields of ocean engineering and hydraulic engineering, in particular to a prediction method for a maximum velocity profile in a wave boundary layer based on velocity defect functions; and the new proposed method can be directly applied to the analysis and prediction for physical quantities/processes, such as characteristics of the wave boundary layer, stress of underwater structures, and starting and transport of submarine sediments.

### BACKGROUND

The distribution of the maximum flow velocity in the boundary layer is closely related to problems of ocean engineering such as stress extremum of underwater structures, and the starting and transport characteristics of the submarine sediments. Therefore, many scholars at home and abroad have systematically studied the characteristics of the boundary layer under different inflow conditions. At present, research on flow structure of the boundary layer under homogeneous inflow conditions has been relatively mature. Through the development of relevant researches, theoretical and empirical prediction formulae which can characterize the characteristics of the boundary layer have been established: that is, under a certain seabed roughness height condition, the flow velocity in a turbulent boundary layer conforms to logarithmic rate distribution law:

$$u ( z ) = \frac{{u}_{*}}{κ} ln ( \frac{30 z}{{k}_{s}} ) \qquad ( 1 )$$

where u(z) indicates a value of horizontal velocity at the vertical coordinate z; u* indicates a submarine friction flow velocity; κ=0.4 indicates a Karman constant coefficient; and kₛ indicates roughness of the seabed.

Compared with the homogeneous flow boundary layer, the researches on the wave boundary layer have experienced a relatively long development process, mainly because the flow velocity distribution in the wave boundary layer is not only spatially related, but also strongly dependent on time (wave phase). Compared with the homogeneous flow boundary layer, the wave boundary layer has the following two obvious characteristics: 1) a velocity overshoot region exists in the wave boundary layer, the flow velocity within the region is greater than that outside the boundary layer, which is usually described as ξ=(Uₛ−Uₘ)/Uₘ, where Uₛ and Uₘ respectively indicate the a velocity overshoot region and a flow velocity amplitude outside the boundary layer, and it should be noted that a velocity overshoot function ξ is also a function of time and space; and 2) phase difference φ exists in the time history of the flow velocity inside and outside the boundary layer. Theoretical solutions of a laminar flow wave boundary layer indicate that the maximum value ξₘₐₓ and φ of the velocity overshoot are constant values, respectively ξₘₐₓ=6.7% and φ=45°. However, a large number of physical experimental results show that the values of ξₘₐₓ and φ in the turbulent boundary layer condition are not fixed, but closely related to seabed roughness height and wave Reynolds number, which are obviously different from the flow structure of laminar boundary layer. By introducing a length scale and exponential parameters, some scholars extend the theoretical solution of the laminar boundary layer to the turbulent boundary layer, establishing a velocity defect function which can predict the spatial and temporal distribution of the turbulent wave flow velocity in the boundary layer. For example:

one-parameter velocity defect function:

$${χ}_{r} ( z ) = exp ( - \frac{z}{λ} ) cos ( \frac{z}{λ} ) \qquad ( 2 )$$

two-parameter velocity defect function:

$${χ}_{r} ( z ) = exp [ - {( \frac{z}{λ} )}^{p} ] cos [ {( \frac{z}{λ} )}^{p} ] \qquad ( 3 )$$

where λ indicates a length scale parameter, p indicates an exponential parameter, and z indicates a vertical coordinate. Taking the two-parameter velocity defect function as an example, the corresponding spatial and temporal distribution of the velocity in the wave boundary layer can be expressed in the following form: u(z,t)=Uₘ cos(on)−Uₘexp[−(z/λ)^{p}]cos[ωt−(z/λ)^{p}], where ω indicates circular frequency of the wave, t indicates the time, and on indicates a wave phase. However, in these velocity defect functions, because a basic theory of the laminar wave boundary layer is still used, an obvious defect that the turbulent boundary layer ξₘ is naturally consistent with the laminar wave boundary layer exists, resulting in poor prediction accuracy of the phase difference φ of the flow velocity inside and outside the wave boundary layer. Therefore, a large error exists in the prediction for the flow velocity distribution of the turbulent boundary layer.

### SUMMARY

In order to solve the above problems existing in the prior art and meet practical requirements of ocean engineering design, construction, etc., the object of the present invention is to provide a fast and accurate prediction method for a maximum velocity profile in a wave boundary layer, and provide accurate hydrodynamic analysis conditions for physical quantities/processes closely being related to the flow structure of the boundary layer such as force assessment of submarine structures, judgment for starting conditions of submarine sediments, transport characteristics of bed load mass etc.

To realize the above purpose, the technical solution of the present invention is as follows: a prediction method for a maximum velocity profile in a wave boundary layer based on velocity defect functions, comprising the following steps:

A. Establishing a Prediction Formula of the Maximum Velocity Profile in the Wave Boundary Layer

Relevant researches that in an existing velocity decay function model, a non-logarithmic rate distribution pattern of the velocity along water depth is adjusted by an exponent p. This is mainly due to the evolution of the wave boundary layer is highly dependent on time; only under specific wave phase conditions can the wave boundary layer develop and mature, and the velocity distribution thereof along the water depth can meet the logarithmic rate law, therefore, it is necessary to introduce the exponential parameter p to describe the velocity distribution law under the condition of the immature wave boundary layer; and in addition, in order to predict the flow velocity distribution of the turbulent wave in the boundary layer, it is necessary to comprehensively consider the effects of seabed roughness height and boundary layer thickness on the velocity distribution, therefore, by considering the effects of the seabed roughness height and the boundary layer thickness on the velocity distribution, the length scale is introduced into the velocity defect functions, to obtain the three-parameter velocity defect function χ(z) for λ₁, λ₂ and p;

$$χ ( z ) = {exp ( - \frac{z}{{λ}_{1}} )}^{p} {cos ( - \frac{z}{{λ}_{2}} )}^{p} \qquad ( 4 )$$

$$u ( z ) = [ 1 - χ ( z ) ] {U}_{m} \qquad ( 5 )$$

where λ₁ and λ₂ are length scales which are respectively used for describing the effects of the seabed roughness height and the boundary layer thickness on the velocity distribution; p is an exponential parameter which is used for adjusting a condition under which the velocity distribution doesn't meet the logarithmic rate law; u(z) indicates the value of the maximum horizontal velocity at the vertical coordinate z; and Uₘ indicates the velocity amplitude of wave water quality point motion in a free-flowing region outside the boundary layer;

the maximum flow velocity profile under a wave condition is indicated by vertical coordinates η₁, η₂ and δ₁; the velocity overshoot region exits inside the wave boundary layer, and η₁ and η₂ respectively indicate a lower boundary and an upper boundary of the velocity overshoot region, that is, η₂−η₁ indicates a scope of the velocity overshoot region; δ_{J} indicates a vertical coordinate corresponding to the maximum velocity in the velocity overshoot region; according to definitions of vertical coordinate physical quantities η₁, η₂ and δ_{J}, binding conditions are obtained: u(η₁)=Uₘ; u(η₂)=Uₘ; when z=δ_{J}, ∂_{χ}/∂_{z}=0; by combining these constraints with formula (4), the expressions of η₁, η₂ and δ_{J} are obtained;

$${η}_{1} = {( \frac{π}{2} )}^{1 / p} {λ}_{2} , {η}_{2} = {( \frac{3 π}{2} )}^{1 / p} {λ}_{2} \qquad ( 6 )$$

$${δ}_{J} = [ π - acr tan ( \frac{{λ}_{2}^{p}}{{λ}_{1}^{p}} ) ] {λ}_{2} \qquad ( 7 )$$

the maximum velocity deviation function max is obtained based on formulae (4), (6) and (7):

$${ξ}_{max} = - {χ}_{r} ( {δ}_{J} ) = \frac{{λ}_{1}^{p}}{\sqrt{{λ}_{1}^{2 p} + {λ}_{2}^{2 p}}} exp [ - \frac{{λ}_{2}^{p}}{{λ}_{1}^{p}} ( π - acr tan ( \frac{{λ}_{2}^{p}}{{λ}_{1}^{p}} ) ) ] \qquad ( 8 )$$

B. Determining Length Scales λ₁, λ₂, and the Exponential Parameter p

by analyzing the formula (8) and experimental results, determining the length scales λ₁, λ₂ and the exponential parameter p in formula (4) using a least square-fitting method a coefficient prediction formula:

$$\frac{{λ}_{1}}{{k}_{s}} = 0.06 {( \frac{A}{{k}_{s}} )}^{0.5} + 0 \text{.041} \qquad ( 9 )$$

$$\frac{{λ}_{2}}{{k}_{s}} = 0.08 {( \frac{A}{{k}_{s}} )}^{0.48} \qquad ( 10 )$$

$$p = 1. 154 - 0.1 \; 42 lg ( \frac{A}{{k}_{s}} ) \qquad ( 11 )$$

where kₛ indicates seabed roughness, and 2.5 times of the element characteristic diameter of the seabed roughness is taken; A indicates displacement amplitude of the water quality point motion of the wave outside the boundary layer, which is calculated by a wave theory; and in the case of nonlinear wave, the maximum displacement amplitude of the water quality point motion of the wave is taken; and

substituting formulae (9), (10) and (11) into formulae (4) and (5) to achieve the prediction for the maximum velocity profile of the wave boundary layer.

In the maximum velocity deviation function ξₘₐₓ, χ(z) degrades to a two-parameter model when λ₁=λ₂=λ; and δ_{J}=λ(3π/4)^{1/p}, ξₘₐₓ=6.7%.

Compared with the prior art, the present invention has the following beneficial effects:

1. the theoretical defects of the existing velocity defect functions are overcome: that is, the maximum overshoot velocity obtained by the current velocity defect functions are consistent with that of the laminar boundary layer (6.7%), realizing the accurate prediction for the maximum overshoot velocity; and in addition, without the assumption of linear wave conditions, the method proposed by the present invention is suitable for nonlinear waves and at the same time, for a small A/kₛ range (0.5<A/kₛ<102), and can be extended to the analysis and prediction for a maximum velocity profile under the condition that the spatial distribution of roughness elements of gravel seabed, etc. obviously affects the flow structure of the boundary layer, which can not be realized by existing research work.

2. Physical experiments and numerical simulation researches are not required. Given the displacement amplitude A and seabed roughness kₛ of the wave water point motion outside the boundary layer, the maximum velocity profile in the wave boundary layer is accurately predicated, thereby greatly improving the prediction accuracy and efficiency.

### DESCRIPTION OF DRAWINGS

FIG. 1 is a setup diagram for a physics experiment.

FIG. 2 shows a relationship between λ₁/kₛ and A/kₛ, and a dotted line in the figure is fitting results of formula (9);

FIG. 3 shows a relationship between λ₂/kₛ and A/kₛ, and a dotted line in the figure is fitting results of formula (10);

FIG. 4 shows a relationship between the exponent p and A/kₛ, and a dotted line in the figure is fitting results of formula (10); and

FIG. 5 shows comparison between the predicted value of a maximum velocity profile of a wave boundary layer and the results of physical experiments carried out by the present invention and others. The solid line in the figure is predication results using formula (4). FIG. 5(a)-FIG. 5(d) are respectively experimental results carried out by others, respectively Jonsson etc.(1976) case 02, Jensen etc.(1989) case 10, Dixen etc. (2008) case p4 and Vander etc. (2011) case S757012; FIG. 5(e)-FIG. 5(h) respectively show results of four working conditions in this method, wherein in a working condition 1, a wave period T=2.25s, Uₘ=0.45 m/s, and A/kₛ=15.07; in a working condition 2, a wave period T=2.25s, Uₘ=0.45 m/s, and A/kₛ=4.26; in a working condition 3, a wave period T=2.25s, Uₘ=0.37 m/s, and A/kₛ=1.69; and in a working condition 4, a wave period T=2.25s, Uₘ=0.37 m/s, and A/kₛ=1.44.

FIG. 6 is comparison between the predicted value of a maximum velocity overshoot max of a wave boundary layer and the results of physical experiments carried out by the present invention and others. The solid line in the figure is predicated results using formula (8). The current experimental working conditions 01 to 04 in FIG. 6 are consistent with the working conditions 1 to 4 in FIG. 5.

In the figures, 1—wave height meter; 2—ADV; 3—rough bottom bed; 4—transition slope; 5—wave making band; and 6—wave eliminating band.

### DETAILED DESCRIPTION

The present invention is further illustrated below in combination with the drawings.

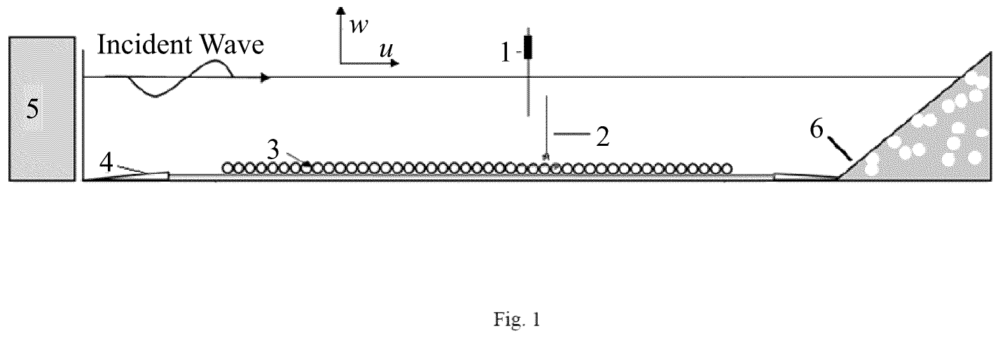

As shown in FIG. 1, the physical experiments conducted by adopting the method in the present invention are as follows:

the physical experiments involved in the present invention are carried out in an oil spilling tank of the State Key Laboratory of Coastal and Offshore Engineering, Dalian University of Technology. The tank is 23 m long, 0.8 m wide and 0.8 m deep. One end of the tank is equipped with a pusher plate type wave maker, to generate waves with a cycle range of 1.0s to 2.5s in the wave making band 5. The other end of the tank is installed with a slope type wave eliminating net for a wave eliminating band 6, to eliminate reflected waves. The test section is arranged in the middle of the tank, and a wave height meter 1 is arranged in the middle of the water surface; and the relevant physical experiment settings are shown in FIG. 1. The experimental terrain is made of concrete, which is 10 m long, 0.8 m wide and 0.13 m high. The transition slope 4 is set at the ratio of 1:15 on both ends of the terrain, to ensure that incident waves propagate slowly to the experimental terrain, and the experimental water depth is 0.4 m. An organic glass plate with length of 6 m and width of 0.8 m is laid on the concrete terrain for arranging a seabed model with different roughness heights. The definition of an experimental coordinate system is shown in FIG. 1, wherein, a horizontal direction is defined as an x-axis, and a travel direction of an incident wave is a positive x-axis; and the water depth direction is defined as a z-axis, a zero point thereof is located at a zero point of a theoretical bottom bed, and the direction of the water bottom pointing to the water surface is the positive z-axis.

In order to study the effect of seabed roughness kₛ on the characteristics of the wave boundary layer, four kinds of rough bottom beds 3 are set in the experiment, which are composed of quartz sand with median diameter d₅₀=3.0 mm, glass spheres with average diameters D=10.6 mm and 26.7 mm, and irregular gravel respectively. The quartz sand and glass sphere rules are pasted on a smooth organic glass plate, and the gravel is directly tiled on the organic glass plate. In the experiment, acoustic doppler velocimetrys (ADV) are used for measuring the vertical distribution of the horizontal flow velocity. The spatial resolution of an ADV 2 is 1 mm, and the flow velocity of 35 measuring points are collected synchronically within the range of 3.5 cm. The distance from an ADV probe to the bottom bed is 7.5 cm, and a starting position through ADV measurement is at 4 cm below the probe; for the seabed composed of quartz sand, the horizontal flow velocity is considered to be homogeneous in a width direction of the tank because the corresponding seabed roughness height is small. Therefore, only one flow velocity measuring point is arranged in the middle of a central axis of an experimental tank; and however, for the seabed composed of glass spheres and gravel, the shape of roughness elements will have an obvious effect on the flow in the wave boundary layer, so it is necessary to arrange multiple measuring points and adopt an ensemble average data processing method, to obtain the average horizontal flow velocity distribution. The relevant calculation formulae are as follows:

$${\overline{u}}_{i} ( ω t , z ) = \frac{1}{M} {\sum }_{i = 1}^{M} {u}_{i} [ ω ( t + ( i - 1 ) T ) , z ] \qquad ( 12 )$$

$$〈 \overline{u} 〉 ( ω t , z ) = \frac{1}{S} {\int }_{S} \overline{u} ( ω t , z ) dS = [ {\sum }_{j = 1}^{N} {\overline{u}}_{j} ( ω t , z ) ] / N \qquad ( 13 )$$

where ūᵢ indicates the average horizontal flow velocity during the period of the ith flow velocity measuring point at the coordinate z; M indicates the number of wave cycles, and in the process of data processing, M is greater than 30; w indicates the wave circle frequency, T indicates the wave period; <ū> indicates the average horizontal velocity after ū passes through space; S indicates an area of a flow velocity measuring region; and N indicates the number of flow velocity measuring points arranged in the experiment.

Two nonlinear second-order Stokes waves, named as wₐ and w_{b}, are set up in the experiment, wherein, wₐ interacts with the rough seabed composed of quartz sand and glass spheres; and w_{b} interacts with the gravel seabed. The present invention mainly focuses on a maximum velocity deviation function ξₘ and the vertical distribution characteristics of maximum horizontal velocity, which are related to the maximum velocity amplitude Uₘ and maximum displacement amplitude A of wave water quality point motion. The peak and trough of the second-order Stokes wave have asymmetrical distribution relative to a static water surface. Therefore, before formal physical experiments are carried out, a wave propagation experiment under the condition of a smooth bottom bed is firstly carried out in order to determine the basic parameters of wave propagation. In this part of the experiment, a time history line of the flow velocity at z=3 cm above the smooth bottom bed is measured by the ADV 2, and the measured results are taken as the free flow velocity unaffected by the boundary layer. Basic parameters of waves measured through the experiment are shown in Table 1:

TABLE 1
Basic Parameters of Nonlinear Second-order
Stokes Wave Used in an Experiment

| No. | T (s) | Uₚ (m/s) | Uₚ/Uₙ | Aₚ (m) | Aₚ/Aₙ |
|---|---|---|---|---|---|
| wₐ | 2.25 | 0.45 | 1.43 | 0.113 | 0.87 |
| w_{b} | 2.25 | 0.37 | 1.54 | 0.0853 | 0.79 |

where Uₚ and Uₙ indicate amplitudes of horizontal flow velocity in the first half cycle and the second half cycle respectively; and Aₚ and Aₙ are horizontal motion amplitudes of wave water quality points in the first half cycle and the second half cycle respectively. As can be seen from Table 1, for the nonlinear waves adopted by the present invention, Uₚ>Uₙ and Aₚ>Aₙ. In order to obtain a maximum flow velocity profile in the wave boundary layer, Uₘ=Uₚ and A=Aₚ are adopted in the subsequent analysis.

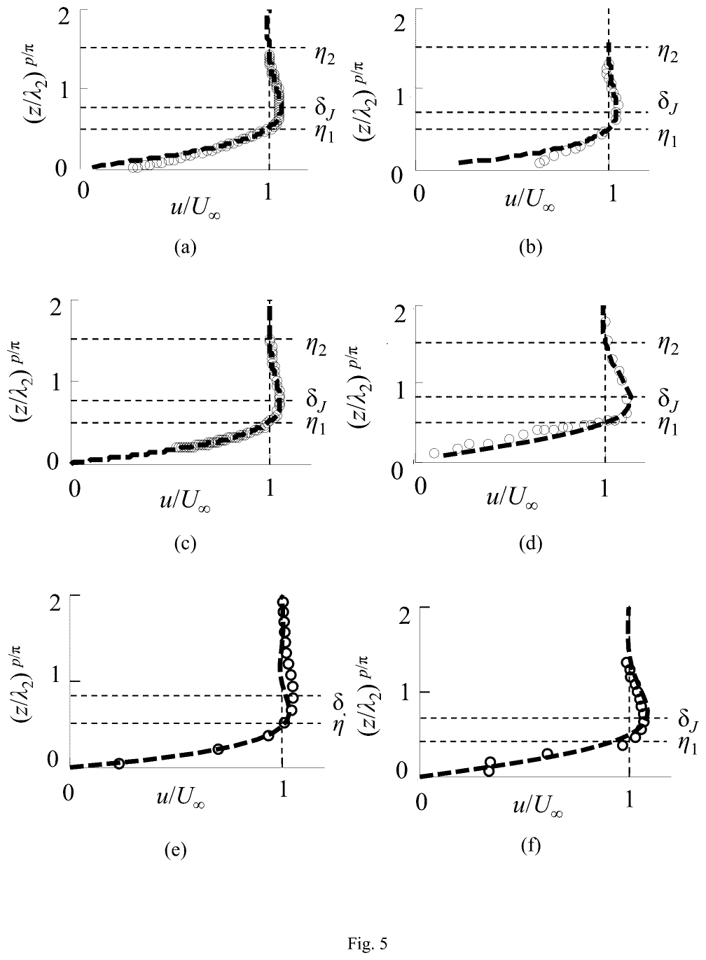

Comparative analyses of the present invention and physical experiments: in the experiment, the velocity in the wave boundary layer under different seabed roughness conditions is measured in real time by the ADV 2. The distribution of the maximum velocity profile in the boundary layer along the water depth is obtained through the analysis of formulae (12) and (13) and is compared with the prediction results of formulae (4) and (5). The relevant results are shown in FIG. 5. In order to further verify the validity of the analytical predication method proposed in the present invention, the relevant predication results are compared with the experimental results of others. As can be seen from FIG. 5, the prediction method for the maximum velocity profile in the wave boundary layer proposed in the present invention has high prediction accuracy, and the error between the predicated value and the measured value of the maximum velocity overshoot ξₘₐₓ is less than 2%.

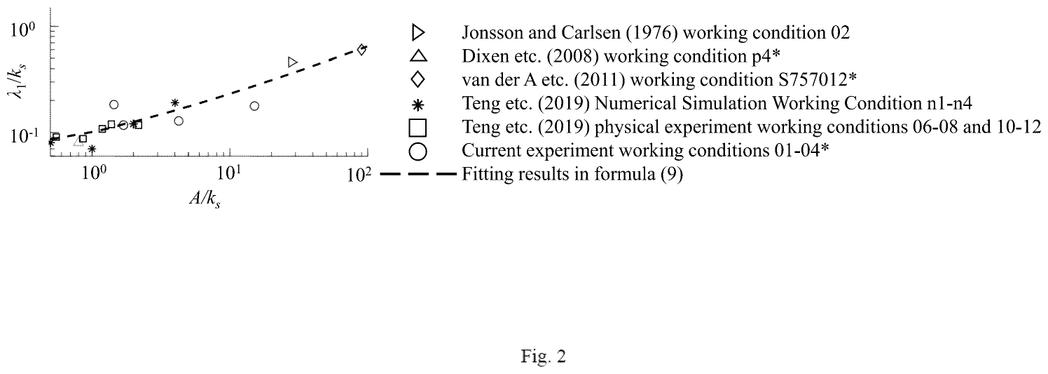

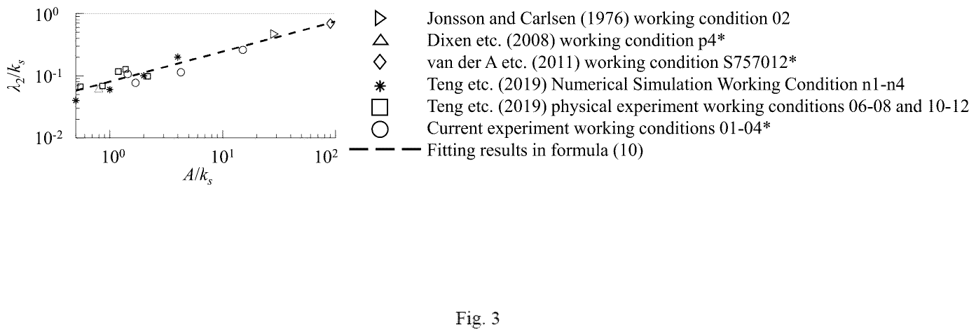

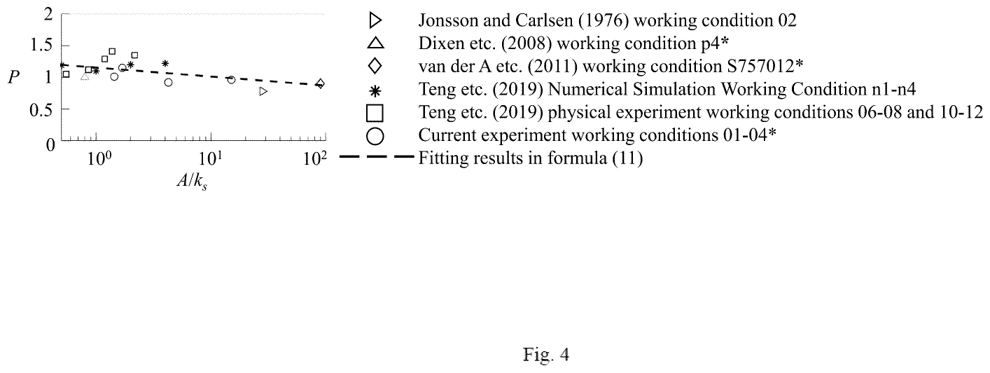

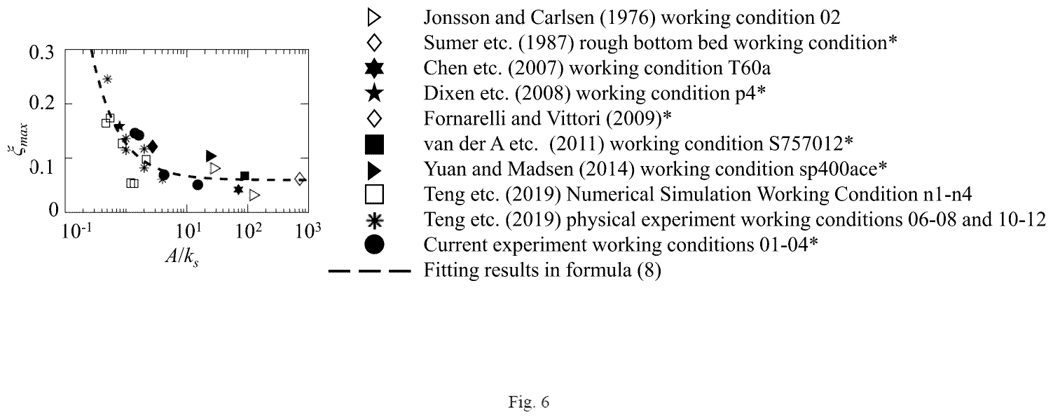

Through the analysis of the relevant data of the physical experiments carried out by the present invention and others, the relationship between two length parameters λ₁, λ₂ and the exponential parameter p in the velocity defect function proposed by the present invention and A/kₛ is analyzed in combination with formulae (6) and (7). The quantitative relationship between λ₁/kₛ, λ₂/kₛ and the exponential parameter p and A/kₛ is established, as shown in formulae (9)-(11) and FIGS. 2-4. The comparison between the maximum velocity overshoot Amax predicted by the prediction method of the present invention with the analytical data of the physical experiments conducted by the present invention and others is given in FIG. 6. As can be seen from the figure, the analysis results of the prediction method proposed by the present invention are in good agreement with the experiment results, which once again prove the validity of the prediction method of the maximum velocity profile of the wave boundary layer based on the velocity defect function proposed by the present invention.

1. A prediction method for a maximum velocity profile in a wave boundary layer based on velocity defect functions, comprising the following steps:
A. establishing a prediction formula of the maximum velocity profile in the wave boundary layer
by considering the effects of the seabed roughness height and the boundary layer thickness on velocity distribution, introducing the length scale into the velocity defect functions, to obtain the three-parameter velocity defect function χ(z) for λ₁, λ₂ and p;
$$χ ( z ) = {exp ( - \frac{z}{{λ}_{1}} )}^{p} {cos ( - \frac{z}{{λ}_{2}} )}^{p} \qquad ( 1 )$$
$$u ( z ) = [ 1 - χ ( z ) ] {U}_{m} \qquad ( 2 )$$
where λ₁ and λ₂ are length scales which are respectively used for describing the effects of the seabed roughness height and the boundary layer thickness on the velocity distribution; p is an exponential parameter which is used for adjusting a condition under which the velocity distribution doesn't meet the logarithmic rate law; u(z) indicates the value of the maximum horizontal velocity at the vertical coordinate z; and Uₘ indicates the velocity amplitude of wave water quality point motion in a free-flowing region outside the boundary layer;
the maximum flow velocity profile under a wave condition is indicated by vertical coordinates η₁, η₂ and δ_{J}; the velocity overshoot region exits inside the wave boundary layer, and η₁ and η₂ respectively indicate a lower boundary and an upper boundary of the velocity overshoot region, that is, η₂−η₁ indicates a scope of the velocity overshoot region; δ_{J} indicates a vertical coordinate corresponding to the maximum velocity in the velocity overshoot region; according to definitions of vertical coordinate physical quantities η₁, η₂ and δ_{J}, binding conditions are obtained: u(η₁)=Uₘ; u(η₂)=Uₘ; when z=δ₁, ∂_{χ}/∂z=0; and by combining these constraints with formula (1), the expressions of η₁, η₂ and δ_{J} are obtained;
$${η}_{1} = {( \frac{π}{2} )}^{1 / p} {λ}_{2} , {η}_{2} = {( \frac{3 π}{2} )}^{1 / p} {λ}_{2} \qquad ( 3 )$$
$${δ}_{J} = [ π - acr tan ( \frac{{λ}_{2}^{p}}{{λ}_{1}^{p}} ) ] {λ}_{2} \qquad ( 4 )$$
the maximum velocity deviation function ξₘₐₓ is obtained based on formulae (1), (3) and (4):
$${ξ}_{max} = - {χ}_{r} ( {δ}_{J} ) = \frac{{λ}_{1}^{p}}{\sqrt{{λ}_{1}^{2 p} + {λ}_{2}^{2 p}}} exp [ - \frac{{λ}_{2}^{p}}{{λ}_{1}^{p}} ( π - acr tan ( \frac{{λ}_{2}^{p}}{{λ}_{1}^{p}} ) ) ] \qquad ( 5 )$$
B. determining length scales λ₁, λ₁, and the exponential parameter p
by analyzing the formula (5) and physical experimental results, determining the length scales λ₁, λ₂ and the exponential parameter p in formula (1) using a least square-fitting method;
a coefficient prediction formula:
$$\frac{{λ}_{1}}{{k}_{s}} = 0.06 {( \frac{A}{{k}_{s}} )}^{0.5} + 0 \text{.041} \qquad ( 6 )$$
$$\frac{{λ}_{2}}{{k}_{s}} = 0.08 {( \frac{A}{{k}_{s}} )}^{0.48} \qquad ( 7 )$$
$$p = 1. 154 - 0.1 \; 42 lg ( \frac{A}{{k}_{s}} ) \qquad ( 8 )$$
where kₛ indicates seabed roughness, and 2.5 times of the element characteristic diameter of the seabed roughness is taken; A indicates displacement amplitude of the water quality point motion of the wave outside the boundary layer, which is calculated by a wave theory; and in the case of nonlinear wave, the maximum displacement amplitude of the water quality point motion of the wave is taken; and
substituting formulae (6), (7) and (8) into formulae (1) and (2) to achieve the prediction for the maximum velocity profile in the wave boundary layer.

2. A prediction method for a maximum velocity profile in a wave boundary layer based on velocity defect functions according to claim 1, in the maximum velocity deviation function ξₘₐₓ, χ(z) degrades to a two-parameter model when λ₁=λ₂=λ; and δ_{J}=λ(3π/4)^{1/p}), ξₘₐₓ=6.7%.
